(19) United States
(12) Patent Application Publication
(10) Pub. No.: US 2016/0303752 A1
(43) Pub. Date: Oct. 20, 2016

(54) Method of, and Apparatus for, Cutting Potatoes

(71) Applicant: Frito-Lay Trading Company GmbH, Berne (CH)

(72) Inventors: Greg HILLIARD, Leicester (UK); Felix STAN, Leicester (UK); Dragos ENACHE, Leicester (UK); Petr KOVALEV, Leicester (UK); Jose Matias HENRIQUES, Leicester (UK)

(21) Appl. No.: 14/783,652

(22) PCT Filed: Oct. 30, 2014
(86) PCT No.: PCT/EP2014/073385

§ 371 Date: Oct. 9, 2015

(30) Foreign Application Priority Data
Nov. 5, 2013 (GB) 1319536.7

(51) Int. Cl. B26D 7/08; C10M 145/26; B26D 3/28

(52) U.S. Cl. CPC B26D 7/088; B26D 3/28; C10M 145/26; A23L 19/12; A23L 19/18; B26D 2210/02; C10M 2207/40; C10M 2209/104; A23V 2002/00

(57) ABSTRACT

A method of cutting potatoes into a plurality of pieces that includes the steps of: (a) providing a potato to a cutting implement; (b) supplying a lubricating liquid onto the cutting implement to form a liquid film over at least part of the cutting edge; and (c) cutting the potato. Also disclosed is an apparatus for cutting the potatoes comprising: a tank for holding a lubricant, an outlet conduit from the tank communicating with an in-line mixer, a water supply conduit to the in-line mixer that is arranged to form a lubricating fluid from the lubricant and water, a mixer output conduit supplying a lubricating liquid from the in-line mixer onto the cutting edge of an implement to form a liquid film over the cutting edge, and an input conduit for adding potatoes to the tank from a potato peeling device.

### CROSS REFERENCE TO RELATED APPLICATIONS

This application is a 35 USC §371 National Stage Application claiming priority from PCT/EP2014/073385 filed Oct. 30, 2014, which in turn claims priority from GB Application 13195356.7 filed Nov. 5, 2013, the technical disclosures of which are hereby incorporated herein by reference.

### BACKGROUND

1. Field of the Invention

The present invention relates to a method of cutting potatoes and to an apparatus for cutting potatoes.

2. Description of the Related Art

Potatoes are cut during the manufacture of a variety of food products, such as potato chips or crisps, and French fries. The potatoes may be sliced or cut into other shapes, for example a French fry shape. There is a loss in yield associated with slicing or cutting potatoes.

During the slicing process, potatoes are fed to a slicing station where a high speed rotating slicer head, including a slicing blade, cuts the potatoes into slices. A water supply is typically used within the slicing operation to help clean the slicer head during operation and provide some form of lubrication for the cutting process.

This yield loss is caused by damage to the potato cell walls by the cutting implement which then results in starch granules being released from the cut potato surface. It is the release of these starch granules that is referred to by those skilled in the art as yield loss. Typically, during potato slicing for potato chip (crisp) manufacture, this yield loss ranges from 9% to 16 wt % of the dry weight of the potato. This can represent a significant loss in productivity, and an associated commercial loss.

There is a need in the art to achieve a reduction in the yield loss, which in turn would directly relate to a reduction in the weight of potatoes required for a given potato chip (crisp) output and therefore achieve a significant improvement in productivity.

### SUMMARY

The present invention at least partially aims to meet this need in the art.

Accordingly, the present invention provides a method of cutting potatoes into a plurality of pieces, the method comprising the steps of:

(a) providing a potato to a cutting implement having a cutting edge for cutting a potato;

(b) supplying a lubricating liquid onto the cutting implement to form a liquid film over at least part of the cutting edge, the lubricating liquid comprising an aqueous dispersion of an antifoam additive; and

(c) cutting the potato using the lubricated cutting edge to cut a potato piece from the potato.

The present invention further provides an apparatus for cutting potatoes into a plurality of pieces, the apparatus comprising a liquid supply mechanism comprising a tank holding a lubricant in the form of a liquid comprising an antifoam additive, an outlet conduit from the tank communicating with an in-line mixer, a water supply conduit for supplying water to the in-line mixer, the water supply conduit communicating with the outlet conduit or an inlet side of the in-line mixer, the in-line mixer being arranged to form a lubricating fluid from the lubricant and the water, the lubricating fluid comprising an aqueous dispersion of the antifoam additive, a mixer output conduit communicating with a cutting implement and having a supply outlet for supplying the lubricating liquid from the in-line mixer onto the cutting implement to form a liquid film over at least part of a cutting edge of the cutting implement, and a second outlet conduit for the tank, the second outlet conduit communicating with a liquid inlet of a potato peeling device.

The present invention further provides the use of a blend of at least one alkylene oxide copolymer and at least one edible oil as a lubricant for cutting potatoes.

### BRIEF DESCRIPTION OF THE DRAWING

FIG. 1 is a schematic side view of an apparatus for cutting potatoes into a plurality of slices during in a potato chip manufacturing line according to an embodiment of the present invention.

### DETAILED DESCRIPTION

Preferred features are defined in the respective dependent claims.

In accordance with the present invention it has been found that the presence of an antifoam additive in the water applied onto the cutting implement during the cutting or slicing operation can reduce the yield loss by reducing the damage to the potato cells, with associated starch loss, during the cutting/slicing operation. It is believed that the antifoam additive can act as a lubricant during the cutting process, which results in a smoother (and therefore less damaged) cut surface of the potato. The reduced damage to the potato cells correspondingly reduces starch loss from the cut surface.

The technical solution to the problem of reducing starch waste during the cutting process is to use, as a lubricant, an antifoam additive that is currently used in the potato chip manufacturing process for the purpose of foam suppression. Surprisingly, it has been found by the present inventors that the known antifoam additive has lubrication properties for the potato cutting operation. Since the known antifoam additive is used throughout the potato manufacturing industry, it is already known to be food safe.

In known potato processing, the antifoam additive is directly dosed into wash tanks in which the peeled potatoes are washed prior to any cutting operation. In accordance with this invention, the antifoam additive is additionally introduced into the process at the cutting operation, as well as at an upstream location, for example during the washing operation for the whole uncut potatoes.

In accordance with the present invention, the antifoam additive lubricant is applied to the cutting implement so as to be applied to the cut potato surface during the cutting operation. This provides an effective reduction in the incidence of cellular damage to the cut potato surface, with an associated reduced starch loss.

In accordance with preferred aspects of the present invention, the antifoam additive lubricant is applied at a concentration which has been found to reduce starch loss, yet with the concentration of lubricant being sufficiently low to so as to minimize the additional material cost to the production process. The increased productivity saving due to reduced starch loss from the potato cutting operation is greater that the additional material cost of the antifoam additive lubricant.

In accordance with preferred aspects of the present invention, it is readily possible to confirm that the lubricant is being applied to the cutting implement because the antifoam additive lubricant tends to form a slightly cloudy dispersion when dispersed in water at the desired concentration range. Thus it can be readily be checked visually, either by an operator or by an inspection device, that the antifoam additive lubricant is present in the aqueous dispersion at the desired concentration range.

In accordance with preferred aspects of the present invention, the antifoam additive is fed into the water feed for the potato slicers from an accurate dosing pump. Such a water feed to the slicers, but without such a lubricant additive, is present in known potato slicer arrangements. The present invention modifies the water flow by adding the lubricant additive so that the lubricant is applied directly to the cutting surface, and is therefore effective to reduce cellular damage to the potatoes, and correspondingly reduce starch losses. Since the existing water flow system only needs to be modified so that the antifoam additive is added to water upstream of the potato slicers, the invention can be readily implemented into an existing potato chip manufacturing facility at minimal additional capital cost.

In accordance with preferred aspects of the present invention, in particular in a method of producing potato slices during the manufacture of potato chips, the potato slices are conveyed to a fryer from the cutting implement. At least a part of the conveying may be carried out by a conveyor in a washing bath. The lubricating liquid from the cutting step is conveyed to the washing bath, typically together with the potato slices, so as to act as an antifoaming agent in the washing bath. Therefore the antifoaming additive provides two functions, first as a lubricant during the cutting step and second as an antifoam to prevent foam build up in the washing bath prior to frying. Preferably, the antifoam additive in the washing bath is provided only by the lubricating liquid supplied onto the cutting implement during the method of producing potato slices and subsequently conveyed to the washing bath. No further antifoam additive needs to be supplied into the washing bath.

The use of the antifoaming additive which is introduced at the cutting stage upstream of the potato slice washing stage therefore can prevent foam build-up and also provides more effective use of the antifoaming additive by additionally acting as a lubricant during the earlier cutting operation.

The method and apparatus of the present invention permit a simple set-up and implementation of the antifoam additive to achieve enhanced productivity and reduced starch losses.

The yield savings, as a result of reduced starch losses which are manifested in increased weight of the potato slices as a proportion of the input whole potato weight, have been found by the present inventors to be typically in the range of from 0.67 to 1.67 wt %, which is a weight saving based on potato dry matter content. The actual value within this range may vary dependent upon the particular antifoam concentration and potato variety.

When antifoam is added to the water feed the water becomes slightly cloudy. This cloudiness may be used as a simple way of identifying the presence of the antifoam, providing a technically simple and low cost manufacturing process and apparatus.

The introduction of the antifoam to the slicer feed water is typically in a very low concentration, typically from 250 to 750 ppm by volume based on the volume of the slicer feed water. For a typical rotatable potato slicing head such a concentration corresponds to a very low feed rate of the antifoam additive lubricant, typically from 150 to 500 ml/hr.

The feed of the lubricating liquid is preferably substantially continuous and at a substantially constant flow rate, in order to provide a smooth supply of lubrication to ensure that there is always antifoam lubricant present in the water feed at the slicer. Such a substantially continuous feed may be provided, for example, by a pump having a minimum of 25 pulses/minute of pumped liquid, for example each pulse having a liquid volume of 0.4 ml.

The preferred embodiments of the present invention modify the point of antifoam introduction from the downstream process dip/speed wash tanks to the upstream slicer water feed. No additional antifoam is required for the process. There is no effect on the product produced and antifoam is a well-known food-safe processing aid, in particular well known for use as a foam suppressant during potato chip manufacture.

An embodiment of the present invention will now be described, by way of example only, with reference to the accompanying drawings in which:

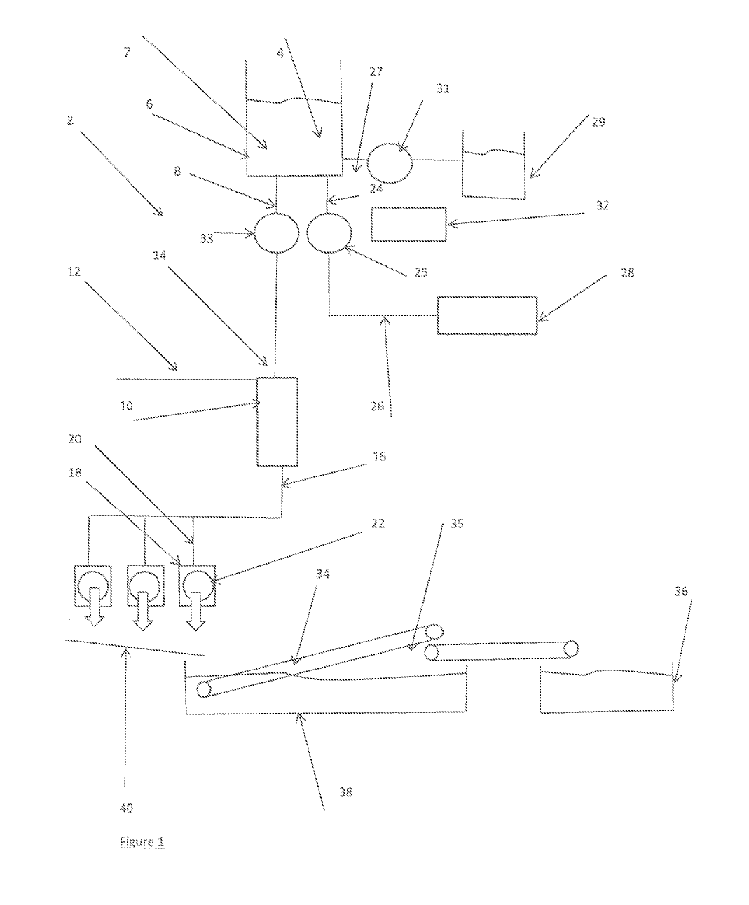

FIG. 1 is a schematic side view of an apparatus for cutting potatoes into a plurality of slices during in a potato chip manufacturing line according to an embodiment of the present invention.

An embodiment of an apparatus for cutting potatoes into a plurality of slices during in a potato chip manufacturing line, according to one aspect of the present invention, is illustrated in FIG. 1.

Referring to FIG. 1, there is provided an apparatus, designated generally as 2, for cutting potatoes into a plurality of pieces. In this embodiment, the pieces are potato slices having a thickness of from 0.5 to 2.5 mm, optionally from 1 to 1.5 mm, for subsequent frying to manufacture potato chips (otherwise known as potato crisps).

A liquid supply mechanism 4 comprises a tank 6 for holding a lubricant 7 in the form of a liquid. The lubricant 7 comprises an antifoam additive, which comprises a blend of at least one alkylene oxide copolymer, such as an ethylene oxide/propylene oxide copolymer, and at least one edible oil, for example a vegetable oil. Such antifoam additives are known for use in potato processing and are well known per se in the art of potato chip manufacture.

An outlet conduit 8 from the tank 6 communicates with an in-line mixer 10. A water supply conduit 12, for supplying water to the in-line mixer 10, communicates with the outlet conduit 8 or an inlet side 14 of the in-line mixer 10. The in-line mixer 10 is arranged to form a lubricating fluid from the lubricant and the water. A mixer output conduit 16 communicates with a cutting implement 18. The mixer output conduit 16 has a supply outlet 20 for supplying the lubricating liquid from the in-line mixer 10 onto the cutting implement 18 to form a liquid film over at least part of a cutting edge 22 of the cutting implement 18.

The cutting implement 18 comprises a rotatable potato slicing head, and preferably a plurality of serially arranged cutting implements 18 are provided, each receiving a lubricant supply from the supply outlet 20.

A pump 33 is located on the outlet conduit 8 for pumping liquid therealong as a substantially continuous liquid flow, and preferably at a substantially constant flow rate.

The pump 33 is controlled to provide that the antifoam additive is present in the lubricating liquid at a desired concentration, typically from 250 to 750 ppm by volume based on the water content of the lubricating liquid.

The antifoam additive in the tank 6 is also supplied to other apparatus in the potato chip manufacturing line to function as a foam suppressor, rather than as a lubricant for the cutting implement 18. A second outlet conduit 24 from the tank 6 communicates with an antifoam supply inlet 26 of a potato peeling device 28. A pump 25 is provided on the second outlet conduit 24 for pumping the outgoing liquid at a desired flow rate. A third outlet conduit 27 from the tank 6 communicates with a fines recovery tank 29. A pump 31 is provided on the third outlet conduit 27 for pumping the outgoing liquid at a desired flow rate.

A controller 32 for the pumps 25, 31 and 33 is provided which is adapted independently to control the liquid flow along the respective conduits 8, 24 and 27 at a desired flow rate.

A conveyor 34 is provided for conveying the potato slices from an outlet of the cutting implement 18 to a fryer 36. The conveyor 34 is part of a process dip/speed wash assembly 35 and is at least partly located in a washing bath 38. A liquid flow mechanism 40 is provided by which the lubricating liquid is conveyed from the cutting implement 18 to the washing bath 38 so as to act as an antifoaming agent in the washing bath 38. Typically, the lubricating liquid is conveyed to the washing bath 38 together with the potato slices, for example using a flume as the liquid flow mechanism 40.

The method of cutting potatoes into a plurality of pieces according to the illustrated embodiment of the present invention will now be described.

Whole potatoes are supplied to the potato peeling device 28 together with a supply of water (not shown). The potato peeling device 28 is also provided with antifoam additive from tank 6 by second outlet conduit 24 to prevent excessive foam generation in the potato peeling device 28.

The peeled potatoes are supplied to the cutting implements 18, which comprise rotatable potato slicing heads.

Lubricating liquid is supplied from supply outlet 20 onto the cutting implements 18 to form a liquid film over at least part of the cutting edges. The lubricating liquid comprises an aqueous dispersion of the antifoam additive from tank 6. The potatoes are cut using the lubricated cutting edges to cut potato slices from the potatoes.

Thereafter, the potato slices are conveyed to the fryer 36 from the cutting implements 18. The conveyor 34 in washing bath 38 is employed for at least a part of the conveying operation. The lubricating liquid from the cutting implements 18 is conveyed, together with the potato slices, to the washing bath 38 so as to act as an antifoaming agent in the washing bath 38. Preferably, the antifoam additive in the washing bath 38 is provided only by the lubricating liquid supplied onto the cutting implements 18 and subsequently conveyed to the washing bath 38.

### EXAMPLES

A number of different potato manufacturing lines were modified to incorporate antifoam addition at the cutting implements in accordance with the embodiment illustrated in FIG. 1. In each case the antifoam additive was present in the lubricating liquid at a concentration of from 250 to 750 ppm by volume based on the water content of the lubricating liquid, the lubricating liquid was pumped as a substantially continuous flow and at a substantially constant flow rate onto the cutting implement, and the antifoam additive comprised a commercial antifoam additive used in potato chip manufacturing, namely a blend of at least one alkylene oxide copolymer and at least one edible oil. The potato varieties which were used varied between the different production lines.

The yield savings, as a weight percentage based on the potato dry matter, are summarized in Table 1.

TABLE 1

| | Yield saving - wt % |
|---|---|
| Example 1 | 0.73 |
| Example 2 | 0.5-1.0 |
| Example 3 | 0.65 |
| Example 4 | 1.2 |
| Example 5 | 0.62 |

It may be seen that the average yield saving was within the range of from 0.65 to 1.2 wt %, with an average saving of typically about 1 wt %, based on the potato dry matter.

Although the illustrated embodiment has been described with particular reference to a rotatable potato slicer head for cutting potato slices during the manufacture of potato chips, or potato crisps, the method and apparatus of the invention may be employed in any application that cuts or slices potatoes to make processed or finished food products, for example a chipping process associated with the manufacture of French fries.

Various modifications to the apparatus and method of the invention as exemplified by the illustrated embodiment will be apparent to the person skilled in the art.

1. A method of cutting potatoes into a plurality of pieces, the method comprising the steps of:
(a) providing a potato to a cutting implement having a cutting edge for cutting a potato;
(b) supplying a lubricating liquid onto the cutting implement to form a liquid film over at least part of the cutting edge, the lubricating liquid comprising an aqueous dispersion of an antifoam additive; and
(c) cutting the potato using the lubricated cutting edge to cut a potato piece from the potato.

2. A method according to claim 1, wherein the potato piece is a potato slice.

3. A method according to claim 2, wherein the potato slice has a thickness of from 0.5 to 2.5 mm.

4. A method according to claim 1, wherein the antifoam additive is present in the lubricating liquid at a concentration of from 250 to 750 ppm by volume based on the water content of the lubricating liquid.

5. A method according to claim 1, wherein the lubricating liquid is pumped as a substantially continuous flow onto the cutting implement.

6. A method according to claim 5, wherein the lubricating liquid is pumped at a substantially constant flow rate onto the cutting implement.

7. A method according to claim 1, wherein the antifoam additive comprises a blend of at least one alkylene oxide copolymer and at least one edible oil.

8. A method according to claim 1, wherein the potato piece is a potato slice and the method further comprises the step (d), subsequent to step (c), of conveying the potato slice to a fryer from the cutting implement, the step (d) using a conveyor in a washing bath for at least a part of the conveying, wherein the lubricating liquid from step (c) is conveyed to the washing bath so as to act as an antifoaming agent in the washing bath.

9. A method according to claim 8, wherein the lubricating liquid from step (c) is conveyed to the washing bath together with the potato slice.

10. A method according to claim 8, wherein the antifoam additive in the washing bath is provided only by the lubricating liquid supplied onto the cutting implement during the method of cutting potato slices and is subsequently conveyed to the washing bath.

11. An apparatus for cutting potatoes into a plurality of pieces, the apparatus comprising a liquid supply mechanism comprising:
a tank configured for holding a lubricant in the form of a liquid comprising an antifoam additive, the tank having a first outlet conduit and a second outlet conduit;
an in-line mixer in fluid communication with the tank via the first outlet conduit;
a water supply conduit for supplying water to the in-line mixer, the water supply conduit communicating with the first outlet conduit or an inlet side of the in-line mixer, the in-line mixer adapted to form a lubricating fluid from the lubricant and the water, the lubricating fluid comprising an aqueous dispersion of the antifoam additive; and
a mixer output conduit having a supply outlet configured for supplying the lubricating liquid from the in-line mixer onto a cutting implement to form a liquid film over at least part of a cutting edge of the cutting implement;
wherein the second outlet conduit for the tank is in fluid communication with a liquid inlet of a potato peeling device.

12. An apparatus according to claim 11, wherein the cutting implement comprises a rotatable potato slicing head.

13. An apparatus according to claim 11, further comprising a first pump located for pumping liquid in the first outlet conduit as a substantially continuous liquid flow.

14. An apparatus according to claim 13, further comprising a controller for the first pump, the controller being adapted to control the substantially continuous liquid flow along the first outlet conduit at a substantially constant flow rate.

15. An apparatus according to claim 11, wherein the supply outlet is adapted to supply the lubricating liquid from the in-line mixer onto a plurality of serially arranged cutting implements.

16. An apparatus according to claim 11, wherein the cutting implement is adapted to produce potato slices for the manufacture of potato chips; and the apparatus further comprises:
a conveyor for conveying the potato slices from an outlet of the cutting implement to a fryer, the conveyor being at least partly located in a washing bath; and
a liquid flow mechanism configured to convey lubricating liquid from the cutting implement to the washing bath so as to act as an antifoaming agent in the washing bath.

17. An apparatus according to claim 16, wherein the liquid flow mechanism is configured to convey lubricating liquid to the washing bath together with potato slices.

18. A method of using a blend of at least one alkylene oxide copolymer and at least one edible oil as a lubricant for a cutting edge for cutting potatoes.

19. The method according to claim 18, wherein the potatoes are cut into potato slices by the cutting edge.

20. The method according to claim 19, wherein the potato slice has a thickness of from 0.5 to 2.5 mm.

21. The method according to claim 18, wherein the blend is present in an aqueous dispersion at a concentration of from 250 to 750 ppm by volume based on the water content of the aqueous dispersion.

22. The method according to claim 18, wherein the lubricant is supplied as a substantially continuous flow onto a cutting implement.

23. The method according to claim 22, wherein the lubricant is supplied at a substantially constant flow rate onto the cutting implement.

24. The method according to claim 18, wherein the at least one alkylene oxide copolymer comprises an ethylene oxide/propylene oxide copolymer and the at least one edible oil comprises a vegetable oil.
